(19) United States
(12) Patent Application Publication
(10) Pub. No.: US 2006/0235886 A1
(43) Pub. Date: Oct. 19, 2006

(54) Method, system and software for centralized generation and storage of individualized requests and results

(75) Inventor: Kimball Norman, McKinney, TX (US)

Correspondence Address: Michael G. Cameron, Suite 600, 2435 N. Central Expressway, Richardson, TX, 75080, US

(73) Assignee: KJN Partners, L.P.

(21) Appl. No.: 11/124,821

(22) Filed: May 9, 2005

Related U.S. Application Data
(60) Provisional application No. 60/671,732, filed on Apr. 15, 2005.

(51) Int. Cl. G06F 17/00; G06F 7/00

(52) U.S. Cl. 707/104.1

(57) ABSTRACT

What is disclosed is a method, system (1000) and software for providing users of networked devices with centralized storage of individualized requests and results, available from any networked devices, regardless of where the requests and/or results are inputted or viewed.

### CROSS-REFERENCE TO RELATED APPLICATION

This application is related to U.S. provisional patent application No. 60/671,732, filed on Apr. 15, 2005, entitled “Method, System and Software for Centralized Generation and Storage of Individualized Requests and Results”, the entire contents of which are incorporated herein by this reference. The Applicant hereby claim the benefits of this earlier pending provisional application under 35 U.S.C. Section 119(e). No federal grants or funds were used in the development of the present invention.

### FIELD OF THE INVENTION

The present invention relates to a method, system and software for providing users of networked web enabled devices with centralized generation and automated storage of individualized requests, results, favorites and browsing history, available from any networked devices, regardless of where the requests are inputted, favorites are saved, browsing occurs, and/or results viewed. As used herein, the term “centralized” refers to a location away from the client user and thus can mean both a single physical server, as well as a plurality of interconnected physical servers. For example, the present invention allows a user to generate and then save, at a centralized server, individualized prior search engine keyword searches, URL locations visited, favorites and/or user names and passwords, regardless of whether these requests have been inputted from one or different web enabled devices. These requests, information and results can then be viewed by the user from any web enabled device via a website located at a centralized web server and by entering a single username and password.

### BACKGROUND OF THE INVENTION

In the past few years there has been an explosive growth in the Internet, and in particular of the World Wide Web (“WWW”), which is one of the facilities provided on the Internet. When used herein, the term Internet and WWW, shall mean the Internet, WWW as well as similar computer network facilities, protocols and transmission means. The WWW comprises many documents or pages or files of information, distributed across many different servers. Each page is identified by a Universal Resource Locator (“URL”). The URL denotes both the server machine, and the particular document or file or page on that machine. There may be many documents or pages or URLs resident on a single server.

In order to use the WWW, a device runs software known as a Web browser. As used herein, the term “device” includes but is not limited to a desktop computer, laptop computer, tablet computer, PDA, web-enabled cell phone, or other presently existing or future web enabled device or client. The device interacts with the browser to select a particular URL, which in turn causes the browser to send a request for that URL or page to the server identified in the URL. Typically, the server responds to the request by retrieving the requested page, and transmitting the data for that page back to the requesting device (the client-server interaction is performed in accordance with the hypertext transport protocol (“HTTP”)). This page is then displayed by the browser to the user of the browser in any web enabled device.

Search sites such as Google, Yahoo and MSN Search permit users of the WWW to search the Web for desired information. The search sites rely on search engines which go out and search the Web for information, which may be indexed and maintained by the search site. The search engines themselves rely on automated software robots, to go out and crawl the Web and collect information about sites. The user searches an index of Web information, by typing key words into a search engine text box.

The results of a simple word search can yield a huge number of “hits”. Thus, users often narrow searches by entering a plurality of search terms. These key words can be saved locally on a memory cache of a device. But if a user is at a different networked device (for example, at a public library, office, work location, or internet cafe or public business center), these prior key words are not available and a user must remember what key words were searched, or locations browsed, or items viewed, for example at an auction site, to find a specific resource. Furthermore, the names of visited URLs and favorites can be saved locally on a memory cache of a networked device. But if a user is at a second, different networked device, the listing of the sites visited from a first networked device or favorites saved thereto are not available and a user must remember which URLs were visited or a list of favorites.

Furthermore, many URLs now require usernames and passwords to access their web pages. These usernames and passwords can be saved locally on a memory cache of a networked device. But if a user is at a different networked device, the user's usernames and passwords are not available and a user must remember which usernames and passwords correlate to the URL to be accessed.

In other words, the “computing environment” made available to a user from a first device is often different from the computing environment made available to that user from another device. Accordingly, a need has developed to enable users of networked devices to have a single, “virtual” computing environment regardless of the location or address of the device. With the present invention, a user accesses a certain URL, through a username and password, and enters into a computing environment having access to a search engine, in which, among other things, a list of all keywords used in searches from that search engine, all URLs previously visited based on results from that search engine, a list of favorites, and all usernames and passwords used in all visited URLs, are stored and made available, regardless of which device was used to originally input such requests and/or information and display the results.

Another aspect of the present invention is the ability of the software of the present invention to generate a list of related keywords correlated to the keywords previously entered by the user into the invention's search engine, and a means of conveniently displaying these generated keywords with the user entered keywords.

Certain terms are used throughout the following description and claims to refer to particular system components. As one skilled in the art will appreciate, companies may refer to a component and sub-components by different names. This document does not intend to distinguish between components that differ in name but not function. In the following discussion and in the claims, the terms “including” and “comprising” are used in an open-ended fashion, and thus should be interpreted to mean “including, but not limited to . . . ”. Also, the term “couple” or “couples” is intended to mean either a direct or indirect electrical connection. Thus, if a first device couples to a second device, that connection may be through a direct electrical connection, or through an indirect electrical connection via other devices and connections. In addition, no distinction is made between a “processor,” “microprocessor,” “microcontroller,” or “central processing unit” (“CPU”) for purposes of this disclosure. To the extent that any term is not specially defined in this specification, the intent is that the term is to be given its plain and ordinary meaning.

### SUMMARY OF INVENTION

The method, system and software of the present invention provides for the storage, online or offline, of user selected keywords, terms, URLs visited, favorite sites, browsing history, database locations and formulas. The program script or code used to implement the present invention can be configured and placed on servers (referred to broadly as input/output devices) of various sizes coupled over communication links to a variety of display input/output devices. Server management programs will provide for the continuous monitoring, scheduling and control of events, jobs and tasks. These server system tools provide disk, database, file and user management services while the server is connected to online storage networks such as the internet, WWW, other open networks, PCS, G2, G3 or intranets for example that have display terminals with input/output abilities accessed by a variety of users.

The method, system and software of the present invention is adapted to permit users (e.g., visitors) or display input/output devices to be registered as a unique user or device with or without a password. This registration will allow the user to store keywords, phrases, database locations, favorites and formulas created or found while searching and viewing online or offline data. The user will be able to sign in and out to access the stored results and request data at any time or from time to time from any device that has access to the centralized server over a communication network.

An object of the present invention is to provide a method, system and software adapted to give users of a Web search engine access to their previously entered request data, locations browsed and generated results data from any networked device.

Another object of the present invention is to provide a method, system and software adapted to give users of the Internet a personalized, dedicated central Web search engine that stores previously used keywords, generates additional keywords and lists previously visited websites.

A further object of the present invention is to provide users of a Web search engine with additional search key words based the key words entered in by the user.

Other objects and advantages of the present invention will be set forth in part in the description and the drawings which follow, and, in part, will be obvious from the description or may be learned by practice of the invention.

To achieve the foregoing objects, and in accordance with the purpose of the invention as broadly described herein, the present invention provides a software implemented process associated with a client and server, the server being employed to provide search information in response to a search engine request from a user at a client, the server having a database associated therewith which includes a means of collecting, storing and displaying URLs and information about documents available on the Internet, requests previously made by the user, websites previously visited by the user and usernames and passwords used by the user.

The present invention also provides a database and related algorithms for generating and displaying key words which are related to key words entered by the user.

The present invention also provides a method, system and software for providing enhanced search results through and individualized document in response to a search request made by a user, the search request being made of a server through an individualized search engine page, the server having a multiple database search function, the server having an index associated therewith of documents available from the plurality of databases.

The present invention will now be described with reference to the following drawings, in which like reference numbers denote the same element throughout.

### BRIEF DESCRIPTION OF THE DRAWINGS

FIG. 1 is an illustration of a screen shot of a “User Sign In”, “New User Sign Up” web page, including a search engine text box;

FIG. 2 is an illustration of the first web page for the “New User Sign Up” process;

FIG. 3 is an illustration of the second web page for the “New User Sign Up” process;

FIG. 4 is an illustration of a “User Sign In” web page;

FIG. 5 is an illustration of an individualized web page showing a search engine text box, search terms previously entered by a user as well as web sites previously visited;

FIG. 6 is an illustration of an individualized auction, store or catalog site web page showing a query text box, and search terms previously entered by a user as well as items previously viewed with browsing history;

FIG. 7 is an illustration of an individualized legal web page showing a query text box, search terms previously entered by a user as well as cases previously viewed with history;

FIG. 8 is an illustration of an individualized medical, government or law enforcement database screenshot showing a query text box, terms previously entered by a user as well as links to information previously viewed with browsing history; and

FIG. 9 is an illustration of an individualized reference database screenshot showing a query text box, terms previously entered by a user as well as links to information previously viewed with browsing history.

FIG. 10 illustrates a block diagram of the hardware architecture;

FIG. 11 is a flowchart of a illustrating an aspect of the present invention;

FIG. 12 is a flowchart of a illustrating an aspect of the present invention;

FIG. 13 is a flowchart of a illustrating an aspect of the present invention;

FIG. 14 is a flowchart of a illustrating an aspect of the present invention

FIG. 15 is a flowchart of a illustrating an aspect of the present invention;

FIG. 16 is a flowchart of a illustrating an aspect of the present invention;

FIG. 17 is a flowchart of a illustrating an aspect of the present invention;

FIG. 18 is a flowchart of a illustrating an aspect of the present invention;

FIG. 19 is a flowchart of a illustrating an aspect of the present invention;

FIG. 20 is a flowchart of a illustrating an aspect of the present invention;

FIG. 21 is a flowchart of a illustrating an aspect of the present invention;

FIG. 22 is a flowchart of a illustrating an aspect of the present invention;

FIG. 23 is a flowchart of a illustrating an aspect of the present invention;

FIG. 24 is a flowchart of a illustrating an aspect of the present invention; and

FIG. 25 is a flowchart of a illustrating an aspect of the present invention.

### DETAILED DESCRIPTION OF THE PRESENT INVENTION

The present invention comprises a method, system and software for providing users of networked devices with centralized generation and storage of individualized requests and results, available from any networked devices, regardless of where the requests and/or results are inputted or viewed. For example, the “virtual” computing environment provided by the present invention may include, but not be limited to: key words searched, key words generated, and web sites visited. However, the foregoing list is not exhaustive of all of the information that can be stored in the individualize search web page. The specific list of information can be preset or programmed by a user of the device using a utility application which provides the user a selectable list of storage data parameters. The user can then select or deselect the data to be stored, as well as delete information that is no longer relevant.

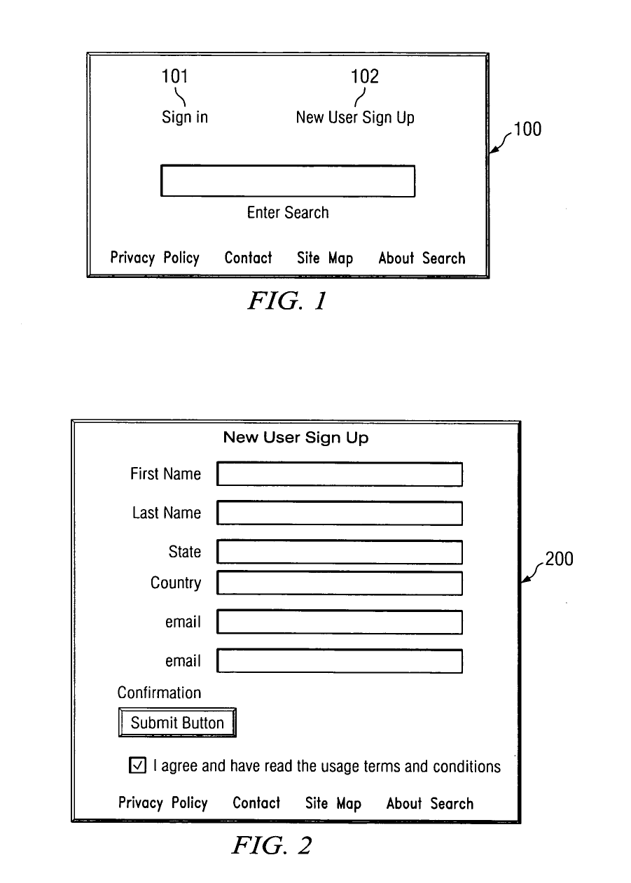

As seen in FIG. 1, a user with access to a variety of input/output devices with a display can register and be able to sign in through a graphical user interface (“GUI”) over a communication link, including but not limited to cable modem, Ethernet, wi-fi, cellular, and the like, into a server or other input/output device that has access to online storage located on the Internet. The server stores user selected data in the form of keywords and locations used on prior visit(s) and/or selected by user for use again after the initial search.

One embodiment of the present invention can be implemented using a server, including, for example, a Dell or IBM server configured with a T-3 communications link over an intranet of the Internet/WWW with an Internet service provider (“ISP”). The server is loaded with server administration software such as, but not limited to, Windows server system/exchange server/ASP.NET 1.1/LINUX. The software which implements the present invention can be any appropriate programming language, including but not limited to Visual Basic. For device installs, the present invention can use software such as, but not limited to, ASP.NET 1.1/LINUX/Fox Pro for static HTML, SGML or XML page online web accessible GUI forms creation of and event management of the database structure for the deployment of the program.

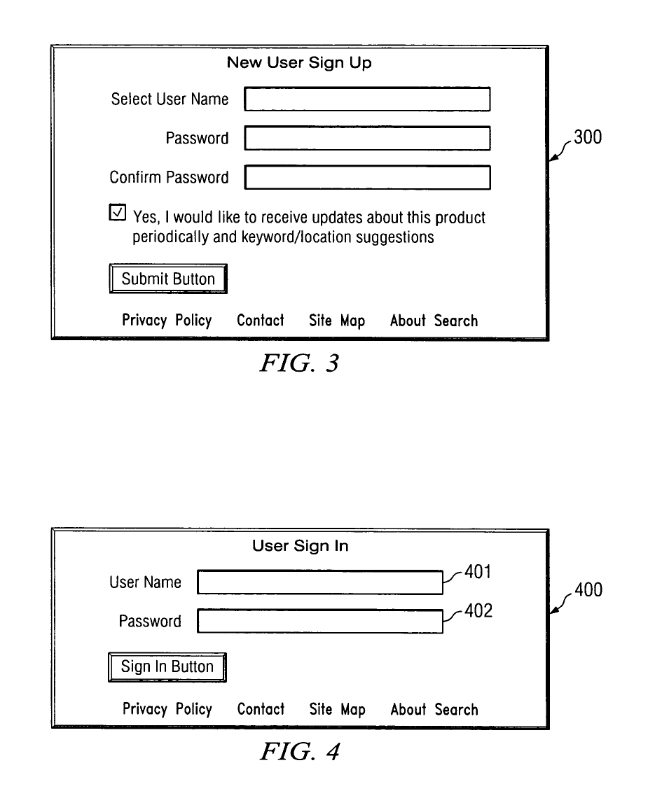

Referring to screenshot 100 of FIG. 1, if a user clicks on “Sign In” 101, he/she is taken to the screen seen in FIG. 4. If a user clicks on “New User Sign Up” 102, the user is taken to the screenshots 200 and 300 seen in FIGS. 2 and 3. FIGS. 2 and 3 illustrate the “New User Sign Up” pages. In these screens, the user creates a unique username and password combination enabling them to access the website from any networked device. As seen in screenshot 400 of FIG. 4, a user can log in by entering their previously established user name and password in textboxes 401, 402.

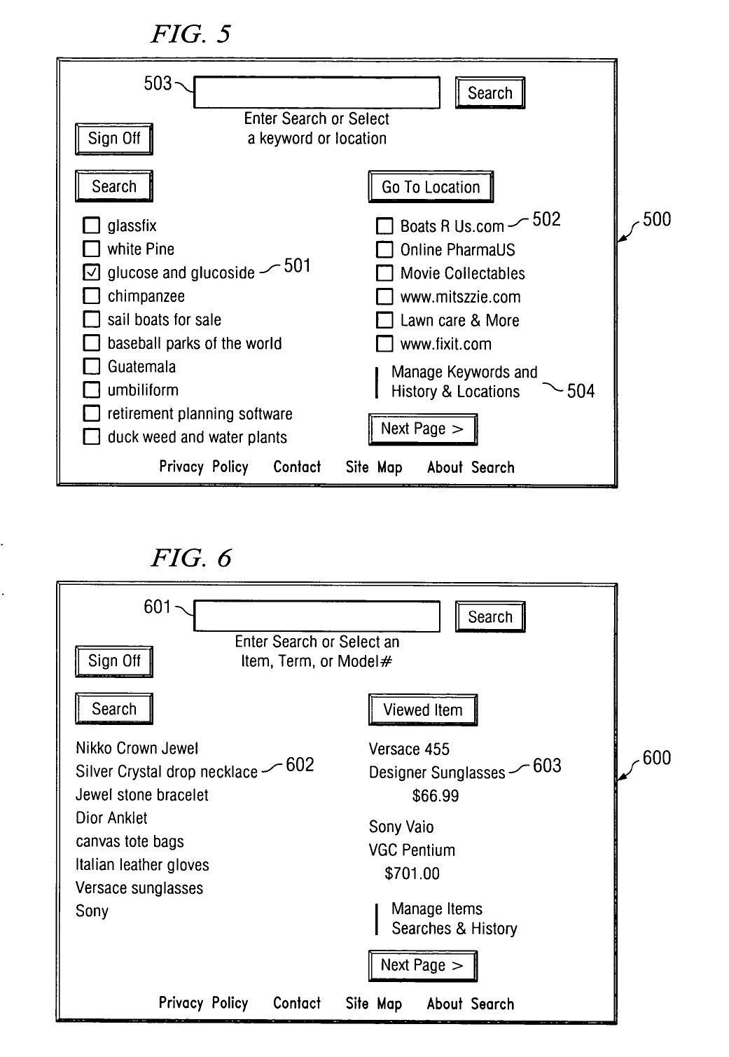

As seen in screenshot 500 of FIG. 5, individualized key words 501 and websites visited 502 are displayed to a user, along with a search engine text box 503. When using the search engine text box 503, a program log saves keywords searched 501 and locations visited 502 for further individualization, modification and management by the user by clicking on “Manage Keywords and locations” 504. The database associated with the user's individualized search engine will keep a record of the user's key words, favorites and Internet/WWW locations visited. The program will provide for the individualized sign in and use of the program for self selection of keywords and locations to be stored for secure storage and later use from other web enabled devices on the Internet/WWW when and while the user is signed into his or her individualized database.

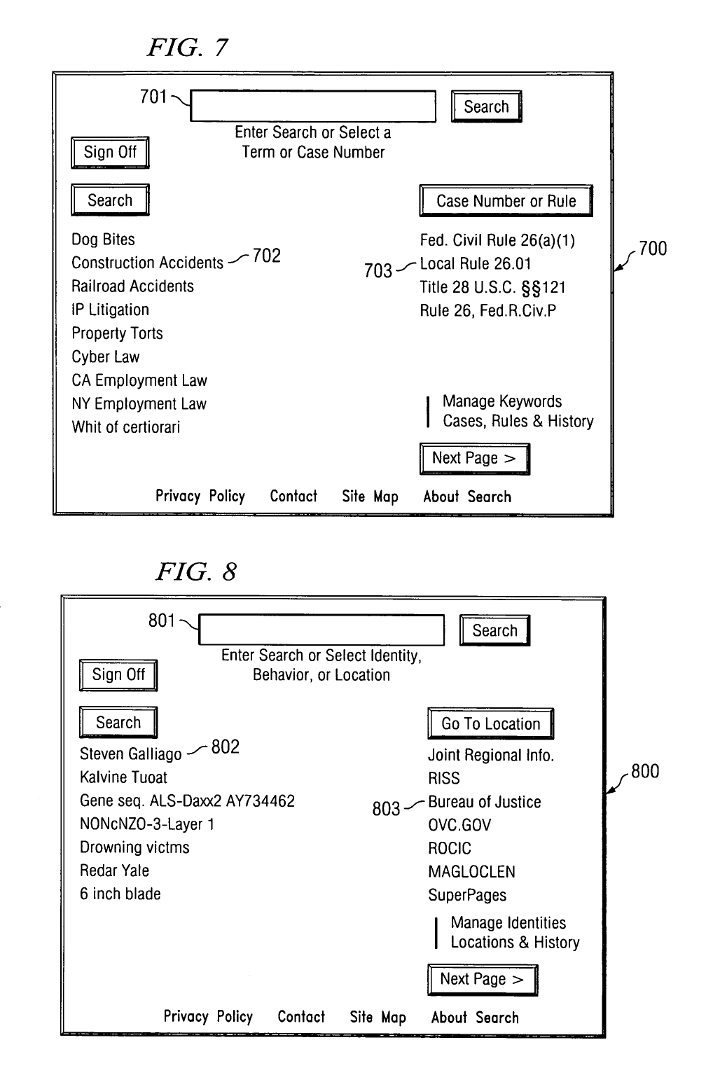

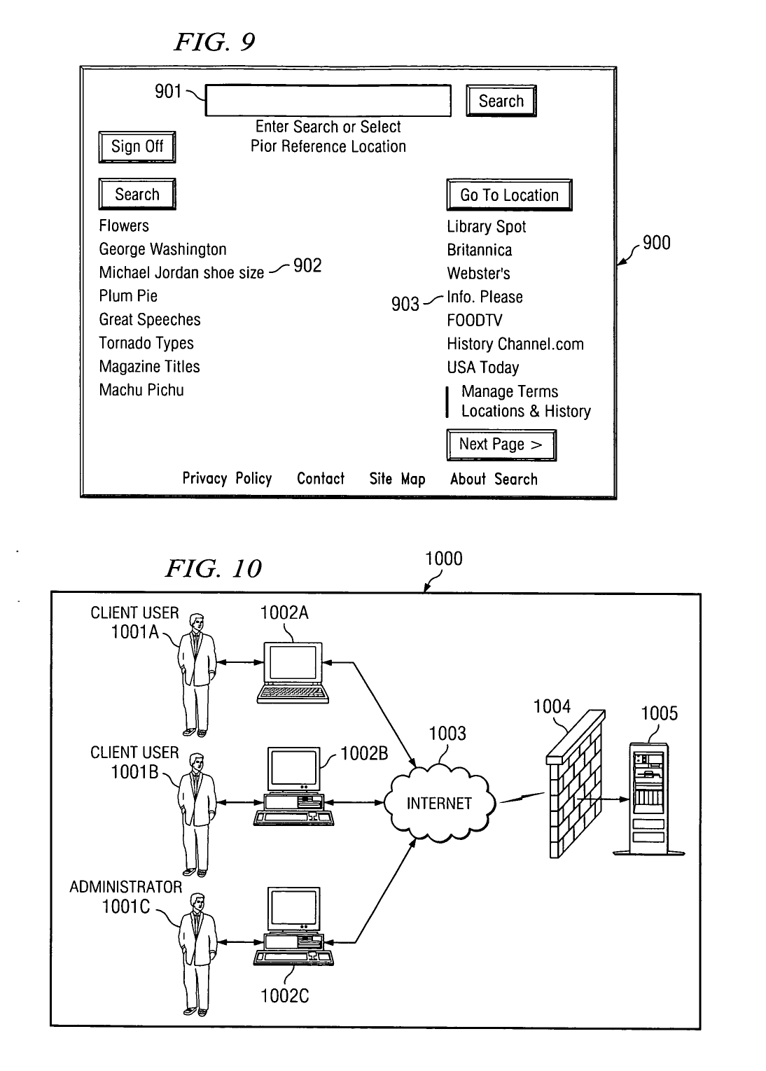

Additional embodiments of the present invention can be seen in FIGS. 6, 7, 8 and 9. Referring to FIG. 6, an individualized auction site web page 600 showing a query text box 601, and search terms 602 previously entered by a user as well as items previously viewed 603 with browsing history can be seen. FIG. 7 is an illustration of an individualized legal web page 700 showing a query text box 701, search terms 702 previously entered by a user as well as cases previously viewed 703. FIG. 8 is an illustration of an individualized medical, government or law enforcement database screenshot 800 showing a query text box 801, terms previously entered by a user 802 as well as links 803 to information previously viewed with browsing history. FIG. 9 is an illustration of an individualized reference database screenshot 900 showing a query text box 901, terms previously entered by a user 902 as well as links to information previously viewed with browsing history 903.

As noted herein, the present invention can be described as an extended version of a search engine. Using the present invention a user can save his searched keywords and links for future use. When implemented over the internet, a website implementing the present invention permits users an easy way to search the web. Such a website includes, among other things, a function to save the user entered search keywords and clicks into a database. This allows users to repeat the search quickly, by choosing the name of the website (an implementation of the present invention uses the website name “savedsearch.com” or “SavedSearch”) rather than re-entering the criteria manually. The user thus will have access to the search keywords and links from anywhere and can also manage the words and the links.

Referring now to the high level design of the system architecture, the SavedSearch Website application architecture comprises of two software components: a user interface component and an administrator interface component. The user interface component, will allow the user of the website to obtain, among other things, the following information: Search History information: The participant (user) can login to view their search History information and also search through using this system. Two views can be provided for the search History: Current search and Managing the search history. The user can also update their personal information on the User Interface component. New users can sign in and obtain access to their search history.

The Administrator Interface component will allow the Administrator to maintain the client sections of the SavedSearch web site. There are two types of administrators present in this system. Client admin and the site administrator. The site administrator can create a client, modify an existing client or delete a client from the system. The site administrator can also audit each client's search history. The client admin can also modify a user and audit each user's search history.

FIG. 10 illustrates the system architecture 1000 in block diagram, showing the client users 1001A-1001N, their computers 1002A-1002N, the internet cloud 1003, a firewall 1004 and a web server 1005 on which the server software of the present invention resides.

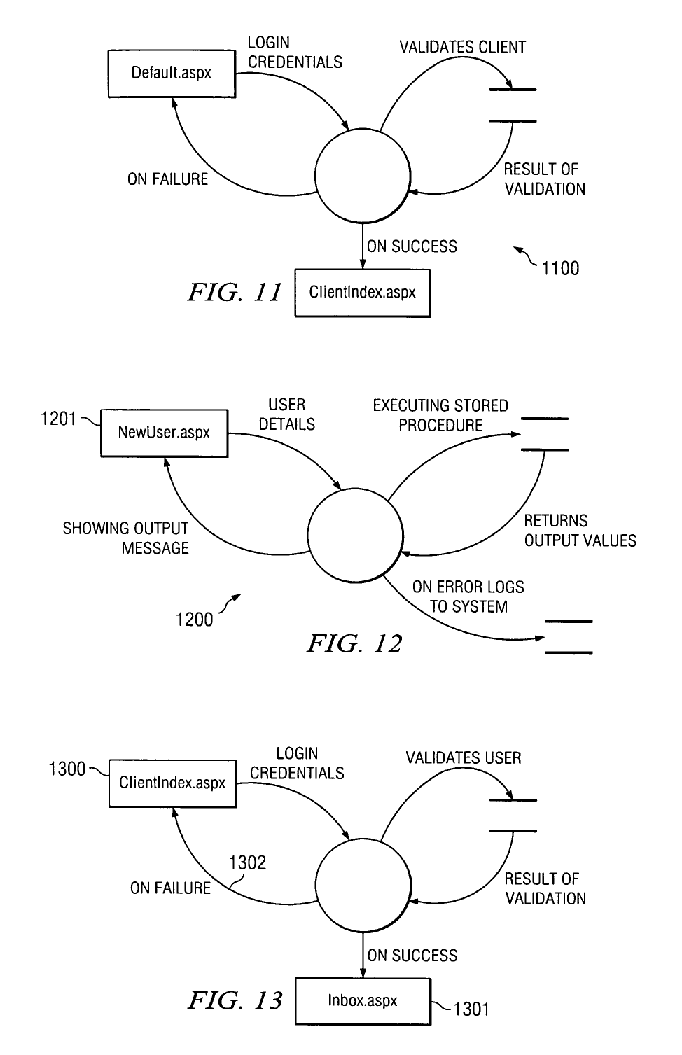

Process flow in the present invention is described as follows: The user module enables a user to login to the system. The user must login as a client first and then must login as a user in order to access SavedSearch facility. If a person is a not user then said person can do a usual search, however, in that case the search keywords and links will not be saved into the SavedSearch facility. FIG. 11 illustrates the client login process 1100 aspect of the present invention. As seen therein, the user enters the username and password. And on validating the credentials, one of two events will occur: upon success the user is directed to the client index page. upon failure, the user is not validated and is returned to the login page.

FIG. 12 illustrates the client login process 1200 aspect of the present invention. After logging in as a client, a user can register as a user for the same client. Alternatively, a user can click on the new user link 1201 and he/she will be served a new page named, for example, newuser.aspx. There the user can provide all required input values, all mandatory fields being marked with “*” and, thus, creates a new user.

FIG. 13 illustrates the two events which can occur upon entering the login credentials and on the validation of credentials 1300. If the validation is successful, then the user is redirected to inbox page 1301 which is designed, for example as a conventional search engine service web page. If there is a failure to validate 1302, a failure message is returned and the program remains on the login page 1300.

In an exemplary embodiment of the present invention, upon successful login, the user can do several things, including, the following: The user can edit his/her profile; the user can manage the saved keywords and URLs; The user can search and use the SavedSearch facility; the user can go directly to the search while clicking on the last searched keywords that are displayed in his inbox or the user can directly go to the web pages via the links that the user visited the prior last time; the user can logout from the system.

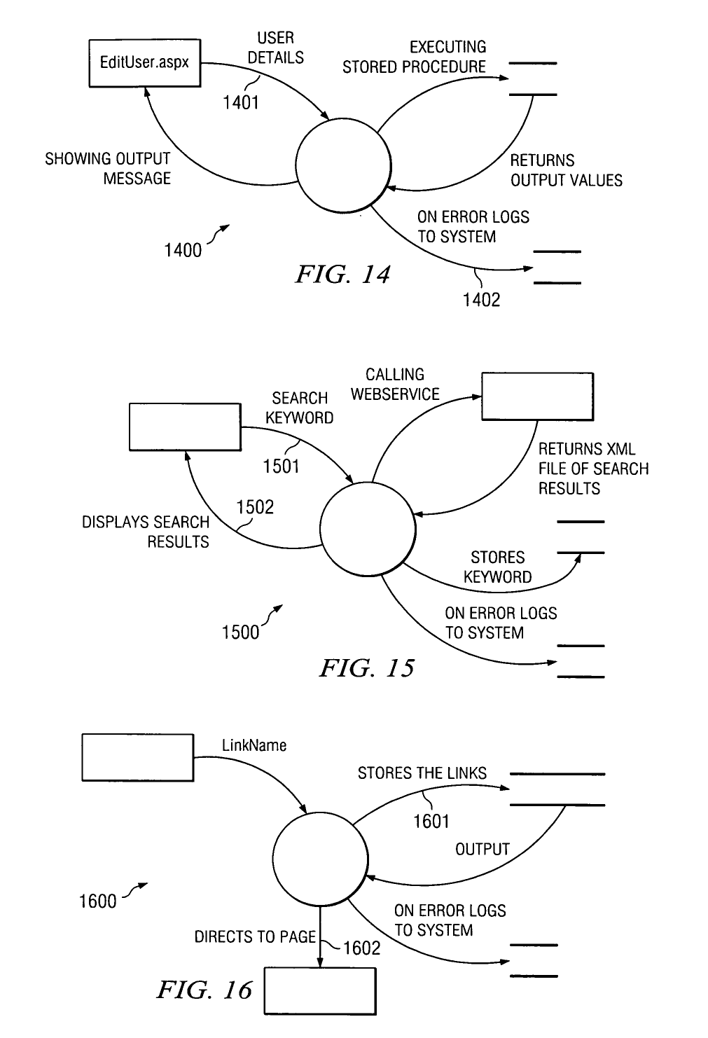

FIG. 14 illustrates the edit profile operation 1400 aspect of the present invention. As seen therein, the user inputs parameters 1401 and clicks save. Upon success, a success message is provided and on failure, the system provides a failure message. If there are any unexpected exceptions, the system logs 1402 these errors and sends an e-mail notice to the webadmin.

FIG. 15 illustrates the searching function 1500 aspect of the present invention. As seen therein, after logging in as user at the client, the user gets all the facilities of the saved search. In this manner, keywords and the links can be saved for the user, and are displayed in his inbox. When a user searches 1501 for keywords, the system provides results 1502 according to the client's opted search engine service and stores the click stream.

Referring to the SavedSearch facility 1600 as seen in FIG. 16, upon clicking the search results, the system saves the link 1601 and directs the user to the appropriate page 1602.

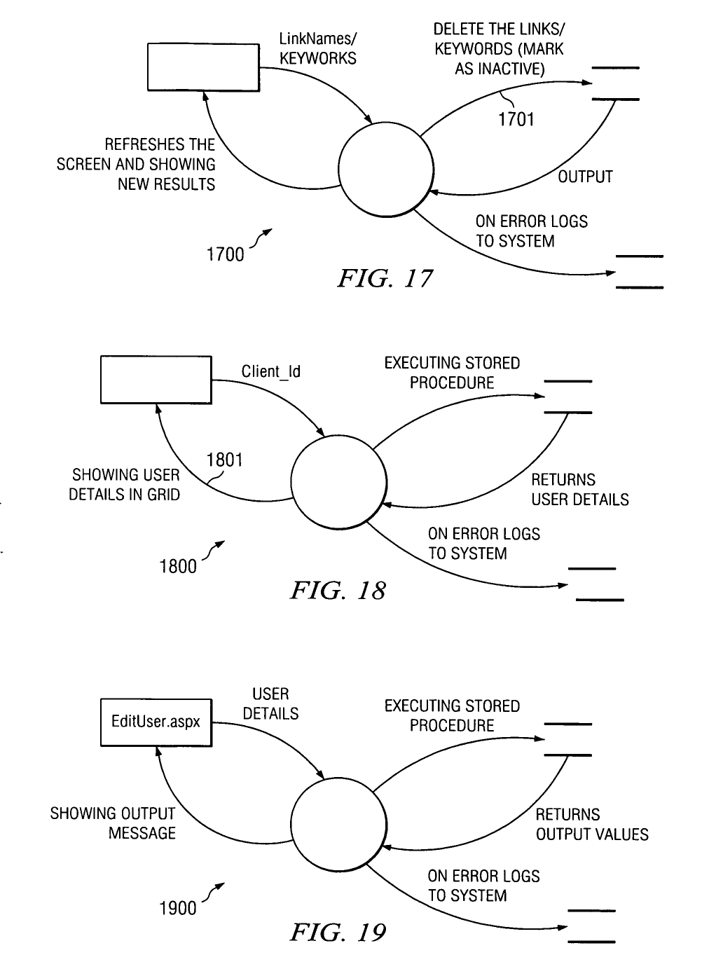

FIG. 17 illustrates the Manage Search operation 1700 aspect of the present invention. As seen therein, the user can delete the saved keywords and URLs 1701 that are no longer needed.

Once a user logs out from the system, he/she cannot use the SavedSearch facility until the user re-logins.

In the client admin module after logging in as a client admin, the admin can undertake a number of operations, including: view the registered user list; manage the users; view the audit trail of any user and logout from the system.

FIG. 18 illustrates aspects of accessing the registered user list using a registered user list facility 1800 aspect of the present invention. In this operation, the admin is provided with a list 1801 to view. The admin can modify the users registered under the particular client

As seen in FIG. 19, the admin can manage users using the manage user facility 1900. The admin can edit user profiles and can restrict a user from using the SavedSearch facility.

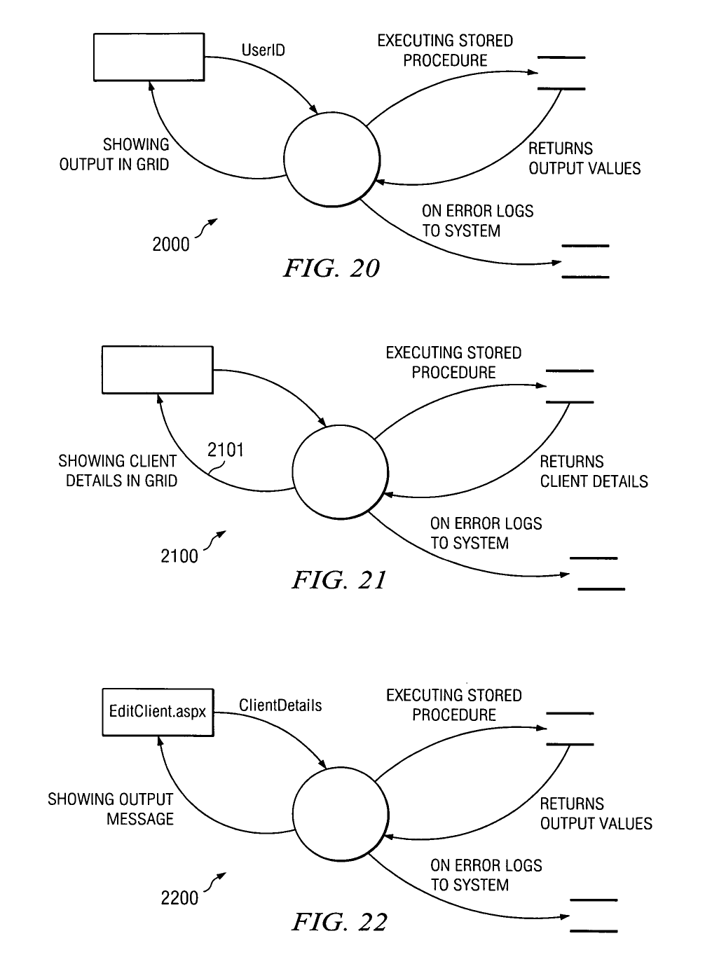

Referring to FIG. 20, the admin can view an audit trail. In this manner, the admin can view each user's search history. Once complete, the admin can logout from the system.

After logging in as site administrator, an admin can undertake a number of operations, including: view the registered client list; manage a client; view an audit trail; add a new client; and logout.

As seen in FIG. 21, in the view registered client list facility 2100 aspect of the present invention, the client admin is provided with the entire client list 2101 of those using the SavedSearch facility.

Referring to FIG. 22, the admin is able to manage the clients using a manage client facility 2200 aspect of the present invention. Using this facility the client admin he can edit a client's profile or restrict a client from using the SavedSearch facility.

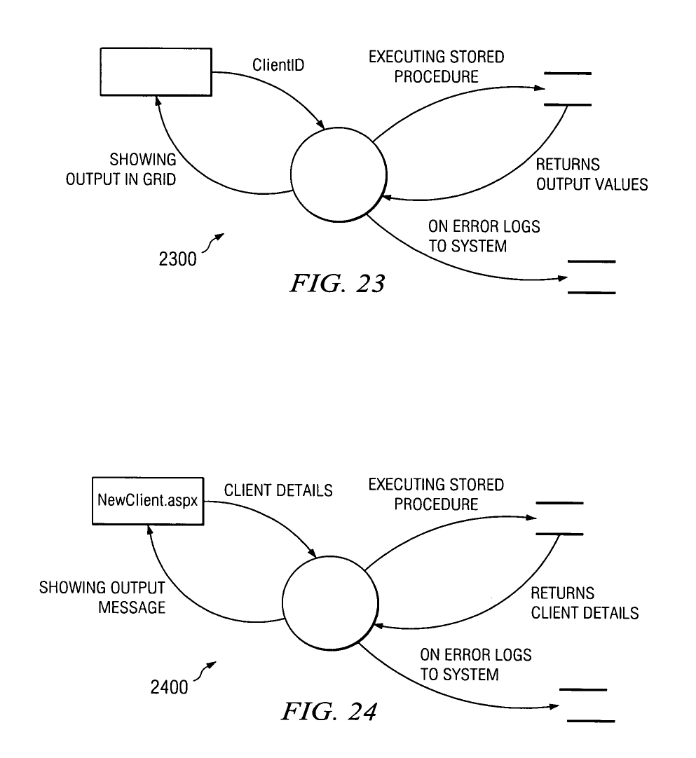

FIG. 23 illustrates the audit trail 2300 aspect of the present invention. Using this feature the client admin can view the entire client's search history.

FIG. 24 illustrates the add new client facility 2400 aspect of the present invention. Using this facility, the client admin can add a new client to the system and generates a userid and password for the client and supply it to the client. Using said userid and password, the client can login to the system.

The log out facility aspect of the present invention allows users to log out from the system.

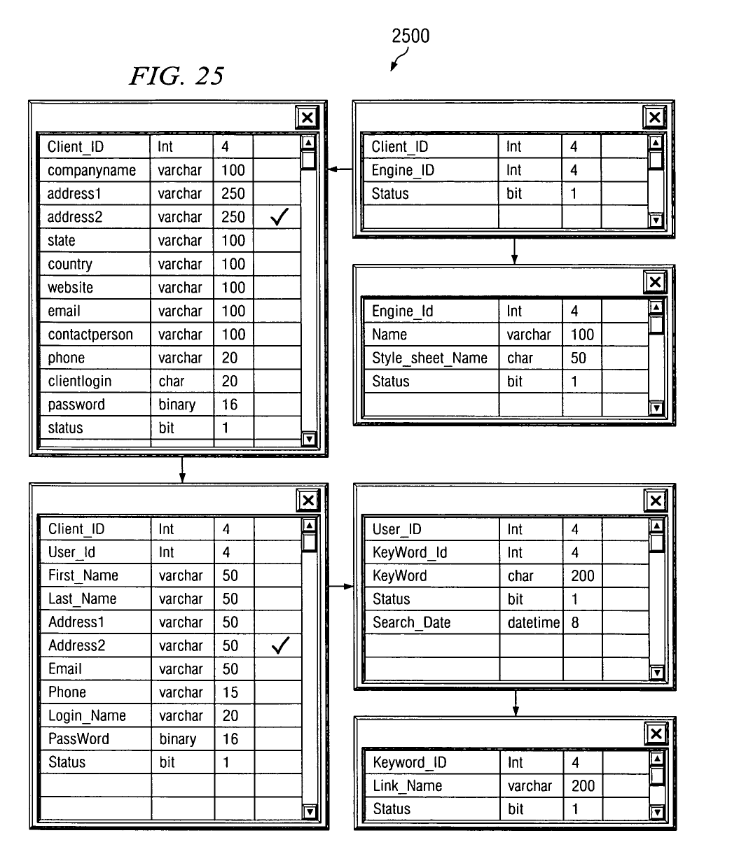

FIG. 25 provides one embodiment of a database design for the present invention using a SQL Server database.

The program will organize and store information in an online database, with offline or online back-up. Information to be stored includes, but is not limited to usernames, passwords, keywords and formulas designated by the user as individualized data for re-use at a later time. Server software, such as the Microsoft exchange server will track users and databases with integration of the final individualized usernames/passwords/keywords/formulas searchable data presented in a GUI form to the user upon sign in. This data will be made available over the World Wide Web and other networks by signing in at the unique GUI.

Advantages of the present invention include the ability of a user to access prior search requests, favorites, key words, URLs visited and the like from any device.

The method and apparatus of the embodiments shown and described above are only exemplary. Even though several characteristics and advantages of the present invention have been set forth in the foregoing description together with details of the invention, the disclosure is illustrative only and changes may be made within the principles of the invention to the full extent indicated by the broad general meaning of the terms used in herein and in the attached claims. In addition to the description of the present invention above, the present invention comprises a individualized search engine website method, comprising providing a user with access to a centralized URL or server through a web enabled device; accessing the centralized URL or server by the user using the web enabled device; generating an individualized search web page and serving it to the web enabled device; inputting request data by the user; displaying result data; and storing request data and result data at the centralized URL or server. The method further comprising automatically correlating to the user and saving to the centralized URL or server a user's browsing history. The request data and result data can consist of, among other things, one from the group of: keywords, URL locations visited, terms searched, favorites, auction items viewed, cases viewed, information viewed and user names and passwords. The method also comprises generating a list of additional keywords relating or similar to the keywords previously entered by the user; generating a list of additional URL locations relating or similar to the URL locations previously entered by the user; generating a list of additional auction items similar to or relating to the auction items previously entered by the user and generating a list of additional cases similar to or relating to cases previously entered by the user. The method is operable to allow access from any web enabled device that is coupled to the centralized URL or server. The method also includes being adapted to have request data inputted into a search engine textbox. The present invention further encompasses a computing system, comprising a centralized server; a first software module operable on a centralized server; a web enabled device operable to access the centralized server; a second software module adapted to run the web-enabled device and adapted to intercommunicate with the first software module; an input means to the web enabled device for inputting request data by a user; a display means of the web enabled device for displaying result data; and the first and second software modules operable to cause a storage means at the centralized server to store request data and result data at the centralized URL or server in an individualized page. Each of the methods described above are implemented using such computing system. The present invention further comprises a software program comprising an algorithm for providing users of networked devices with individualized, centralized generation and storage and access of inputted request data and displayed result data, accessible regardless of where the request data and result data are inputted or viewed. Said software program is adapted to store a user's prior keywords, URLs, database locations visited, favorites and/or user names and passwords; is claimed in combination with computer hardware having input/output and memory, said computer hardware being configured by such software program; and is adapted to provide access from any web enabled device that is coupled to the centralized URL or server.

1. An individualized search engine website method, comprising:
accessing a centralized URL or data base server through a web enabled device;
providing request data to the centralized URL or data base server;
performing a search of the input data;
generating result data as an individualized search web page as a function of the search; and
storing the request data and selectively storing the result data at the centralized URL or data base server.

2. The method of claim 1 making the stored request data and the stored result data available to a second web enabled device.

3. The method of claim 1, further comprising automatically correlating multiple said search web pages to a single user to create a user's browsing and key word search history.

4. The method of claim 1, wherein the request data and result data consist of one from the group of: keywords, URL or server locations visited, terms searched, favorites, cases viewed, information viewed and user names and passwords.

5. The method of claim 4, further comprising generating a list of additional keywords relating to or similar to the keywords previously entered by the user.

6. The method of claim 4, further comprising the result data comprising one or more URL's.

7. The method of claim 4, further comprising generating a list of server locations similar to or relating to the items previously entered by the user.

8. The method of claim 4, further comprising generating a list of additional cases similar to or relating to cases previously entered by the user.

9. The method of claim 2 wherein the second web enabled device is physically remote from the centralized URL or data base server.

10. The method of claim 1, wherein the request data is inputted into a search engine textbox.

11. A computing system, comprising:
a centralized server operable to communicate with a first web enabled device, the data base server being operable to execute a search based on request data received from the web enabled device and create result data;
memory coupled to the centralized server and adapted to store the request data and the result data in an individualized page;
means adapted to enable a user to selectively store the result data; and
means adapted to make the request data and result data available to a second web enabled device.

12. The system of claim 11 wherein the memory is operable to store URL's as the result data.

13. The system of claim 11, wherein the request data and result data consist of one from the group of keywords, URL or database locations, cases, favorites and user names and passwords.

14. The system of claim 13, further comprising means operable to generate a list of additional keywords relating to or similar to the keywords previously entered by the user.

15. The system of claim 13, further comprising means operable to generate a list of additional URL locations relating to or similar to the URL locations previously entered by the user.

16. The system of claim 13, further comprising means operable to generate a list of server locations items relating to or similar to the items previously entered by the user.

17. The system of claim 13, further comprising means operable to generate a list of additional cases relating to or similar to cases previously entered by the user.

18. The system of claim 12, further being configured to provide access to any web enabled device that is coupled to the centralized URL or data base server.

19. A computer readable medium including instructions for:
receiving request data from a user;
enabling a search to be performed on the request data;
generating an individualized search web page as a function of the search;
selectively storing the search web page; and
making the stored search web page available for viewing by a web enabled device.

20. The computer readable medium of claim 19, wherein the request data and result data comprises prior keywords, URLs, database locations, cases, favorites and/or user names and passwords.

21. The computer readable medium of claim 20 further comprising instructions for making the search web page available to a web enabled device physically remote from the computer readable medium.

22. The computer readable medium of claim 20, wherein the request data and result data comprises prior keywords, URLs, database locations, cases, favorites and/or user names and passwords.

23. The method of claim 1, further comprising the step of selectively deleting the result data from the centralized URL or data base server.

24. The method of claim 23, wherein the deleted result data is one or more URL's.

25. The method of claim 1, wherein a user enables the selective storing of the result data.

26. The method of claim 23, wherein a user enables the selective deleting of the result data.

27. The method of claim 11, further comprising means adapted to enable a user to selectively delete the result data.

28. The method of claim 19, further comprising instructions for selectively deleting the search web page.
